(19) United States
(12) Patent Application Publication
(10) Pub. No.: US 2026/0319984 A1
(43) Pub. Date: Oct. 15, 2026

(54) Controlling NICs with DPU

(71) Applicant: Mellanox Technologies, Ltd., Yokneam (IL)

(72) Inventors: Masoud Moshref Javadi, Northville, MI (US); Bodong Wang, Austin, TX (US); Parav Pandit, Bangalore (IN); Ron Yuval Efraim, Tzor Hadash (IL); Arnon Sattinger, Zichron Yaakov (IL); Devarshi Patel, Cary, NC (US); Itay Kuperstein, Haifa (IL); Ahmad Omary, Nien village (IL)

(21) Appl. No.: 19/392,270

(22) Filed: Nov. 18, 2025

Related U.S. Application Data
(60) Provisional application No. 63/785,654, filed on Apr. 9, 2025.

(51) Int. Cl. G06F 13/38; G06F 13/40; G06F 13/42

(52) U.S. Cl. CPC G06F 13/382; G06F 13/4022; G06F 13/4221; G06F 2213/0026; G06F 2213/3808

(57) ABSTRACT

In one embodiment, a network node comprises a host device including at least one processor, a plurality of network interface controllers (NICs) connected to the host device, and a data processing unit (DPU) connected to the NICs via at least one data communication bus, the DPU is to control network functionality of the NICs using control data sent via the at least one data communication bus.

### RELATED APPLICATION INFORMATION

The present application claims benefit of U.S. Provisional Patent Application Ser. No. 63/785,654 of or Javadi, et al., filed 9 Apr. 2025, the disclosure of which is hereby incorporated herein by reference.

### FIELD OF THE DISCLOSURE

The present disclosure relates to computer networking systems, and more particularly but not exclusively to controlling network interface controllers using a data processing unit.

### BACKGROUND

Computer systems often utilize network interface controllers (NICs) to facilitate communication between devices and networks. These NICs typically handle data transfer and network protocol processing, offloading some of the networking tasks from the main processor. In many computing environments, multiple NICs may be employed to manage different types of network traffic or to provide redundancy.

Data processing units (DPUs) have emerged as specialized components that can handle more complex networking and data processing tasks. DPUs often incorporate their own processing cores and memory, allowing them to perform advanced functions beyond those of traditional NICs. This capability enables DPUs to take on additional responsibilities in managing network traffic and implementing security policies.

In some computing architectures, there is a distinction between north-south and east-west network traffic. North-south traffic generally refers to data moving between the internal network and external networks, while east-west traffic describes communication between devices within the same network or data center. Managing these different traffic patterns efficiently can be challenging, especially in environments with high performance requirements.

Bare metal configurations, where applications run directly on hardware without a hypervisor layer, are sometimes used to maximize performance and resource utilization. However, these setups can present challenges in terms of network management and security, as traditional virtualization-based approaches may not be applicable.

As computing systems become more complex and distributed, there is an ongoing effort to improve network performance, security, and manageability. This includes exploring new ways to leverage specialized hardware components and optimizing the interaction between different parts of the system architecture.

### OVERVIEW

There is provided in accordance with an embodiment of the present disclosure, a network node, comprising a host device including at least one processor, a plurality of network interface controllers (NICs) connected to the host device, and a data processing unit (DPU) connected to the NICs via at least one data communication bus, the DPU is to control network functionality of the NICs using control data sent via the at least one data communication bus.

Further in accordance with an embodiment of the present disclosure, the DPU processes north-south network traffic and the NICs process east-west network traffic, north-south network traffic comprises data communication between the host device and external networks, and east-west network traffic comprises data communications between devices within a same network or data center as the host device.

Still further in accordance with an embodiment of the present disclosure, the DPU is directly connected to at least some of the NICs via the at least one data communication bus.

Additionally in accordance with an embodiment of the present disclosure, the control data is sent from the DPU to the NICs not via the host device.

Moreover, in accordance with an embodiment of the present disclosure, the DPU and the NICs are directly connected to the host device via the at least one data communication bus.

Further in accordance with an embodiment of the present disclosure, the DPU is connected to at least some of the NICs via a data communication bus switch.

Still further in accordance with an embodiment of the present disclosure, the DPU is not directly connected to the host device.

Additionally in accordance with an embodiment of the present disclosure, the DPU is directly connected to the NICs via the at least one data communication bus.

Moreover, in accordance with an embodiment of the present disclosure, the at least one data communication bus includes at least one Peripheral Component Interconnect Express (PCIe) data bus.

Further in accordance with an embodiment of the present disclosure, the DPU is directly connected to a subset of the NICs via the at least one data communication bus, and the subset of NICs are directly connected to others of the NICs via the at least one data communication bus.

Still further in accordance with an embodiment of the present disclosure, the control data sets encapsulation parameters for network packets processed by the NICs.

Additionally in accordance with an embodiment of the present disclosure, the control data sets encryption parameters for network traffic handled by the NICs.

Moreover, in accordance with an embodiment of the present disclosure, the control data sets quality of service parameters for network traffic processed by the NICs.

Further in accordance with an embodiment of the present disclosure, the host device is a bare metal device.

There is provided in accordance with another embodiment of the present disclosure, a system, comprising a plurality of network nodes, each network node comprising a host device including at least one processor, a plurality of network interface controllers (NICs) connected to the host device, and a data processing unit (DPU) connected to the NICs via at least one data communication bus, the DPU to control network functionality of the NICs using control data sent via the at least one data communication bus, and a network interconnecting the plurality of network nodes, wherein the DPUs of the network nodes coordinate to manage network traffic across the system.

Further in accordance with an embodiment of the present disclosure, for each network node, the DPU processes north-south network traffic and the NICs process east-west network traffic, north-south network traffic comprises data communication between the host devices and external networks, and east-west network traffic comprises data communications between the host devices within a same network or data center.

Still further in accordance with an embodiment of the present disclosure, the control data sets encapsulation parameters for network packets processed by the NICs.

Additionally in accordance with an embodiment of the present disclosure, the control data sets encryption parameters for network traffic handled by the NICs.

Moreover, in accordance with an embodiment of the present disclosure, the control data sets quality of service parameters for network traffic processed by the NICs.

There is also provided in accordance with still another embodiment of the present disclosure, a method for managing network traffic in a network node, comprising providing a host device including at least one processor, connecting a plurality of network interface controllers (NICs) to the host device, connecting a data processing unit (DPU) to the NICs via at least one data communication bus, controlling network functionality of the NICs using control data sent from the DPU via the at least one data communication bus, processing north-south network traffic using the DPU, wherein north-south network traffic comprises data communications between the host device and external networks, and processing east-west network traffic using the NICs, wherein east-west network traffic comprises data communications between devices within a same network or data center as the host device.

### BRIEF DESCRIPTION OF THE DRAWINGS

The present disclosure will be understood from the following detailed description, taken in conjunction with the drawings in which:

FIG. 1 is a simplified block diagram of a computer node constructed and operative in accordance with an embodiment of the present disclosure;

FIG. 2 is a more detailed block diagram of the computer node of FIG. 1, according to an aspect of the present disclosure;

FIG. 3 is a block diagram illustrating an alternative configuration of the computer node of FIG. 1, in accordance with an embodiment;

FIG. 4 is a block diagram depicting another configuration of the computer node of FIG. 1, according to aspects of the present disclosure;

FIG. 5 is a block diagram showing a variation of the computer node configuration of FIG. 4, in accordance with an embodiment; and

FIG. 6 is a block diagram illustrating software and hardware components of the computer node of FIG. 1, according to aspects of the present disclosure.

### DESCRIPTION OF EXAMPLE EMBODIMENTS

### Overview of Example Embodiments

In modern computing environments, managing network traffic efficiently and securely is becoming increasingly complex. Traditional approaches often rely on host-based network management, which can introduce security vulnerabilities and performance bottlenecks, especially in bare metal configurations where hypervisor-based isolation is not available. Additionally, the distinction between north-south and east-west network traffic may entail specialized handling to optimize performance and maintain security.

Current solutions may involve using data processing units (DPUs) to manage north-south traffic, while network interface controllers (NICs) handle east-west traffic. However, this approach can lead to challenges in coordinating network policies and ensuring consistent security measures across different traffic types. Furthermore, existing methods may involve running control software on the host device, which can compromise the isolation and security benefits of bare metal configurations.

Embodiments of the present disclosure address at least some of the above drawbacks by providing a system and method that enables a data processing unit (DPU) to directly control the functionality of multiple network interface controllers (NICs) without host involvement.

In some embodiments, the DPU is connected to the NICs via high-speed data communication buses, such as PCIe, allowing for efficient transfer of control data. This architecture enables the DPU to manage both north-south and east-west traffic policies consistently, enhancing security and performance.

In some cases, the DPU can implement advanced network functions such as encryption, encapsulation, and quality of service management across connected NICs. This centralized control allows for more sophisticated and uniform network policies to be applied across the entire system.

The solution provided by the present disclosure offers several advantages, including improved security through isolation of network control functions from the host device, enhanced performance by offloading network management tasks from the host CPU and memory, and greater flexibility in implementing complex network policies across different types of network traffic.

### System Description

In the context of this disclosure, the following definitions apply:

A “data processing unit” (DPU) may refer to a specialized processing device configured to offload and accelerate networking, storage, and security workloads. In some cases, a DPU may include multiple processing cores, such as ARM cores, to handle various computational tasks. A DPU may also include a network interface controller (NIC) component. In some cases, the processing cores and NIC component of a DPU may be integrated on the same chip, while in other implementations they may be on separate chips. DPUs may also be referred to as smart NICs in some contexts, reflecting their enhanced capabilities compared to traditional NICs.

A “network interface controller” (NIC) may refer to a hardware component that connects a computing device to a computer network. In some cases, NICs may be low power, high bandwidth devices designed for efficient data transfer.

A “host device” may refer to a computing system that runs applications, processes data, and interacts with other devices (e.g., other host devices) or networks. In some cases, a host device may include one or more processors, memory, storage, and various input/output interfaces. Host devices may take different forms, such as servers, workstations, or specialized computing nodes in a data center or cloud environment. In some implementations, a host device may operate in a bare metal configuration, running applications directly on the hardware, while in other cases it may utilize virtualization technologies to support multiple operating systems or workloads.

“North-south network traffic” may refer to data communication between host devices and external networks. This type of traffic typically involves interactions with clients, users, or services outside the immediate network or data center.

“East-west network traffic” may refer to data communication between host devices within the same network or data center. This type of traffic typically involves interactions between servers or applications within the internal network infrastructure. In some implementations, the east-west network is completely separate or isolated from the north-south network, given its different requirements and characteristics.

A “bare metal configuration” may refer to a computing environment where a physical server is dedicated to a single tenant, without the use of a hypervisor or virtualization layer. In some cases, the operating system may be installed directly on the hardware. In such configurations, the cloud provider typically has limited control over what software is running on the host device.

A “hypervisor” may refer to a software layer that enables the creation and management of virtual machines. In some cases, hypervisors allow multiple operating systems to run concurrently on a single physical host machine by abstracting the underlying hardware resources. In virtualized environments, hypervisors may play a role in resource allocation, isolation between virtual machines, and facilitating communication between virtual and physical components.

A “data communication bus” may refer to a system within a computer or device that transfers data between components. In some cases, a data communication bus may include a Peripheral Component Interconnect Express (PCIe) data bus.

A “processor” may refer to a hardware component within a computing device that carries out instructions of a computer program. In some cases, a processor may be a central processing unit (CPU) or a graphics processing unit (GPU).

A “data communication bus switch” may refer to a device that connects multiple data communication buses, allowing data to be routed between different components or devices connected to these buses.

A “storage device” may refer to a hardware component used to store digital information. In some cases, storage devices may include solid-state drives (SSDs), hard disk drives (HDDs), or other forms of non-volatile memory.

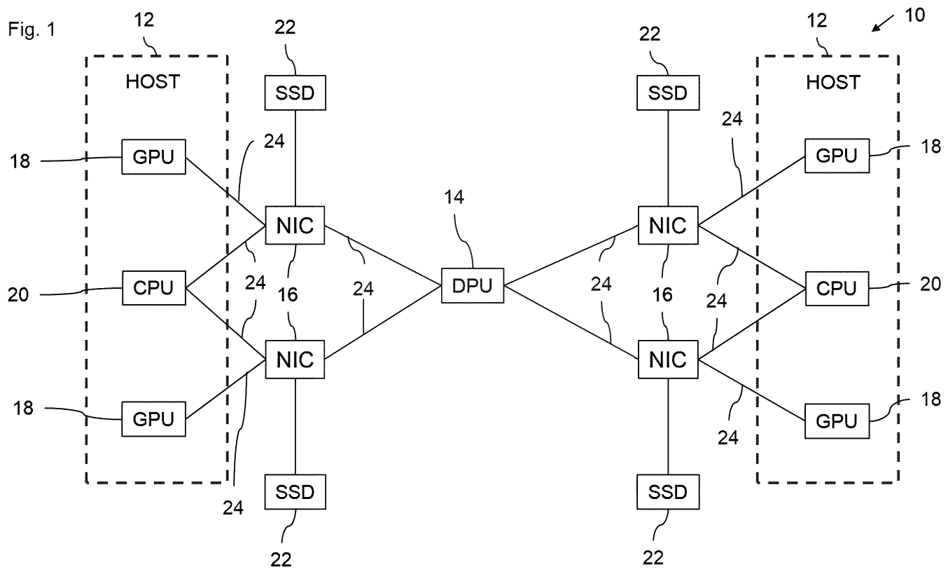

Reference is now made to FIG. 1, which is a block diagram illustrating a computer node 10 according to some embodiments. The computer node 10 may include a host device 12, multiple network interface controllers 16, and a data processing unit 14. The computer node 10 may also include storage devices 22.

The host device 12 may include at least one processor, such as a graphics processing unit 18 and/or a central processing unit 20. In some cases, the host device 12 may be configured as a bare metal device, meaning it does not run a hypervisor or virtualization layer. In other embodiments, the host device may run a hypervisor with one or more virtual machines.

The network interface controllers 16 may be connected to the host device 12 via data communication buses 24. The network interface controllers 16 may process network traffic between devices within the same network or data center.

The data processing unit 14 may be connected to the network interface controllers 16 via data communication bus(es) 24. The data processing unit 14 may be configured to control network functionality of the network interface controllers 16 using control data sent via the data communication bus(es) 24. This architecture enables the data processing unit 14 to manage the network interface controllers 16 without having software running on the host device 12 for that purpose.

In some cases, multiple computer nodes 10 may be interconnected by a network to form a larger system. The data processing units 14 of the different computer nodes 10 may coordinate to manage network traffic across the entire system.

This approach of using a data processing unit 14 to control network interface controllers 16 in a bare metal configuration may provide benefits for network management and security. For example, the data processing unit 14 may implement security policies, manage quality of service, and handle network virtualization tasks on the network interface controllers 16 without impacting performance of the host device 12. Additionally, this architecture may allow for more granular control over network traffic while maintaining the performance advantages of a bare metal configuration.

The network interface controllers 16 may process east-west network traffic between devices within a network, while the data processing unit 14 may process north-south network traffic between the host device 12 and external networks.

The data communication buses 24 may provide direct connections between the data processing unit 14 and the network interface controllers 16. This configuration allows control data to be sent from the data processing unit 14 to the network interface controllers 16 without passing through the host device 12.

In some cases, the network interface controllers 16 may be connected to each other via data communication buses 24, enabling communication between the network interface controllers 16. The storage devices 22 may be connected to the network interface controllers 16 via data communication buses 24 or any suitable data connection.

The data processing unit 14 and the network interface controllers 16 may be directly connected to the host device 12 via the data communication buses 24. This direct connection allows for efficient communication and control between these components.

In some embodiments, the data communication buses 24 may be implemented as Peripheral Component Interconnect Express (PCIe) data buses or PCIe networks, providing high-speed communication between the various components of the computer node 10. While not explicitly shown for brevity, PCIe switches may be present on any of the data communication buses 24 to facilitate connectivity between the various components.

The computer node 10 architecture described in FIG. 1 allows for efficient control of network functionality by the data processing unit 14, while maintaining direct connections between the host device 12, network interface controllers 16, and storage devices 22. This configuration may enable improved performance and flexibility in managing network traffic within the computer node 10.

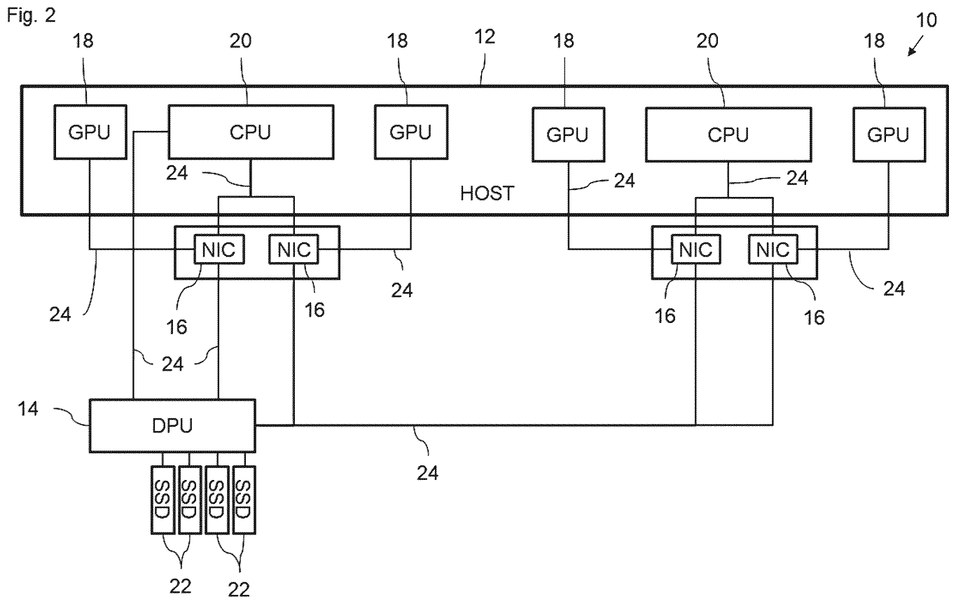

Reference is now made to FIG. 2, which is a detailed block diagram of a configuration of computer node 10. The host device 12 may contain multiple graphics processing units (GPUs) 18 and central processing units (CPUs) 20. In some cases, the GPUs 18 and CPUs 20 may be interconnected by data communication buses 24. The arrangement of multiple GPUs 18 and CPUs 20 within the host device 12 may allow for parallel processing and enhanced computational capabilities.

The computer node 10 may include multiple network interface controllers (NICs) 16 connected to the host device 12 via data communication buses 24. In some cases, the NICs 16 may be arranged in pairs. The DPU 14 may be connected to each pair of NICs 16 through separate data communication buses 24. This arrangement may allow the DPU 14 to efficiently manage and control the network functionality of multiple NICs 16 simultaneously.

In some cases, storage devices 22 may be connected to the DPU 14. The DPU 14 may be configured to communicate with the NICs 16 via the data communication buses 24 to control network functionality of the NICs 16.

The data communication buses 24 may provide connections between the components, allowing data transfer between the GPUs 18, CPUs 20, NICs 16, and DPU 14. In some cases, the data communication buses 24 may be Peripheral Component Interconnect Express (PCIe) buses.

In some cases, the DPU 14 may also be connected to one of the CPUs 20. This connection may allow for direct communication between the DPU 14 and the host device 12, potentially enabling more efficient coordination of network-related tasks.

The arrangement shown in FIG. 2 may provide several advantages. For example, the direct connection between the DPU 14 and pairs of NICs 16 may allow for efficient control and management of network traffic without burdening the host device 12. Additionally, the multiple GPUs 18 and CPUs 20 within the host device 12 may enable high-performance computing capabilities, while the DPU 14 handles network-related tasks.

In some alternative embodiments, the number of GPUs 18, CPUs 20, and NICs 16 may vary depending on the specific requirements of the computer node 10. For instance, there may be more or fewer GPUs 18 or CPUs 20, or a different ratio of GPUs 18 to CPUs 20. Similarly, the number of NICs 16 and their arrangement may be adjusted based on the network requirements of the computer node 10.

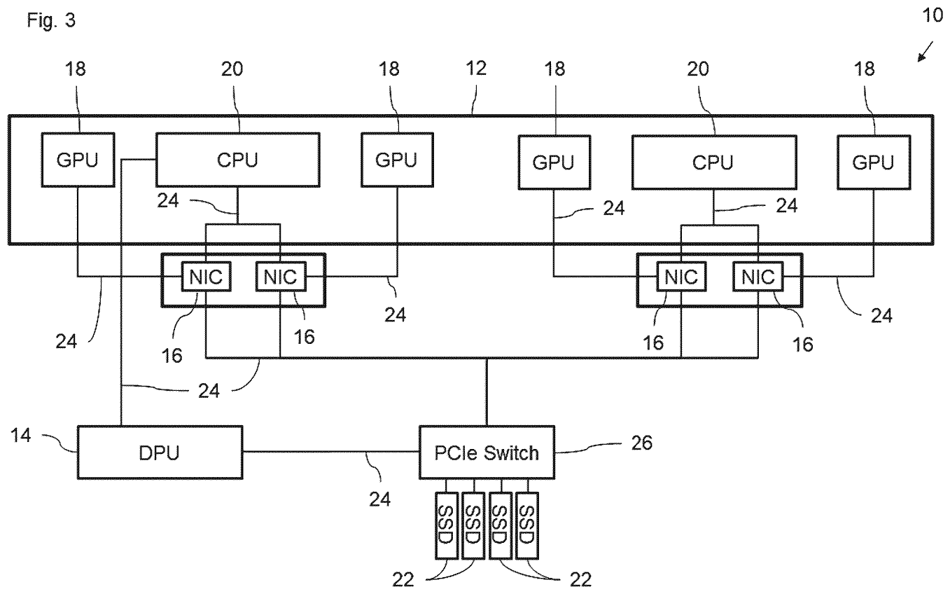

Reference is now made to FIG. 3, which is a detailed block diagram of yet another configuration of computer node 10. In the configuration shown in FIG. 3, the NICs 16 are connected to the host device 12 via data communication buses 24. The DPU 14 is connected to the NICs 16 via a data communication bus switch 26 and data communication buses 24.

The data communication bus switch 26 plays a role in connecting the DPU 14 to the NICs 16. This configuration differs from those shown in FIG. 1 and FIG. 2, where the DPU 14 was directly connected to the NICs 16 without an intermediary switch. The introduction of the data communication bus switch 26 may allow for more flexible routing of control signals and data between the DPU 14 and the NICs 16.

In some cases, the data communication bus switch 26 may be connected to one or more storage devices 22. This connection may provide additional data storage and retrieval capabilities for the computer node 10.

The DPU 14 may control network functionality of the NICs 16 through control data sent over the data communication buses 24 and through the data communication bus switch 26. This arrangement may allow the DPU 14 to efficiently manage multiple NICs 16 while potentially reducing the number of direct connections between the DPU 14 and individual NICs 16.

In some cases, the NICs 16 may process east-west network traffic between devices within the same network, while the DPU 14 may process north-south network traffic between the host device 12 and external networks. The data communication buses 24 may provide connections between the various components, enabling high-bandwidth data transfer throughout the computer node 10.

The configuration shown in FIG. 3 may offer advantages in terms of scalability and flexibility compared to the direct connections shown in previous figures. The data communication bus switch 26 may allow for easier addition or removal of NICs 16 without involving changes to the DPU 14 connections.

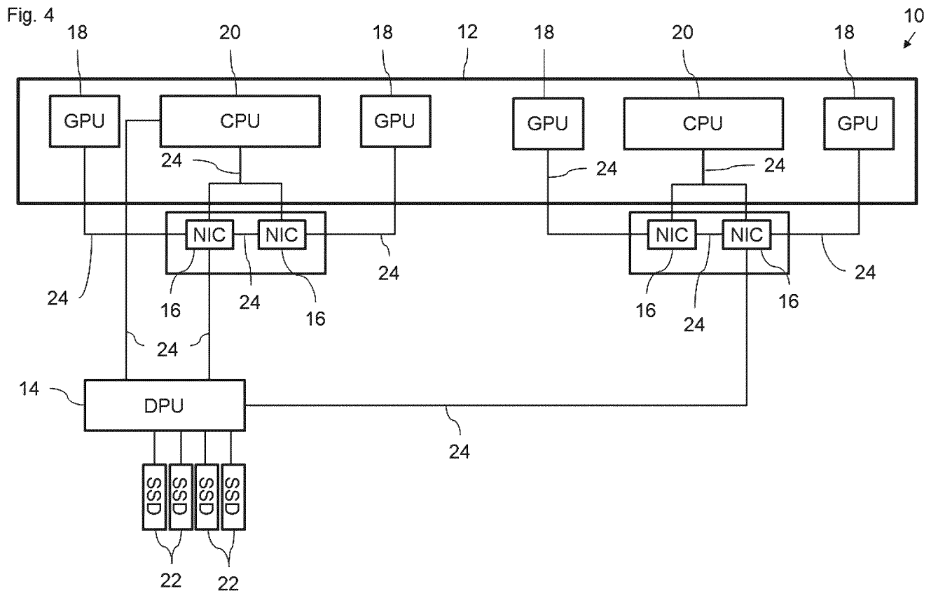

Reference is now made to FIG. 4, which is a detailed block diagram of a further configuration of computer node 10 according to some embodiments. The NICs 16 may be arranged in a daisy chain topology, where a subset of the NICs 16 are directly connected to the DPU 14 via data communication buses 24, and these NICs 16 are in turn connected to other NICs 16 via additional data communication buses 24. Each of the NICs 16 is connected to the host device 12 via data communication buses 24.

The DPU 14 may be configured to control network functionality of the NICs 16 by sending control data through the data communication buses 24. This daisy chain configuration allows the DPU 14 to indirectly control NICs 16 that are not directly connected to the DPU 14. In some cases, the control data may propagate through the chain of NICs 16, enabling the DPU 14 to manage network operations across NICs 16 without direct connections to each one.

In some embodiments, the DPU 14 may not be directly connected to the host device 12. Instead, the DPU 14 may communicate with the host device 12 indirectly through the chain of NICs 16. This configuration may provide enhanced security and isolation between the DPU 14 and the host device 12. In other embodiments, the DPU 14 is directly connected to the host device 12 via one of the CPUs 20.

The computer node 10 may also include one or more storage devices 22 connected to the DPU 14. These storage devices 22 may be used to store data processed by the computer node 10 or configuration information for the DPU 14 and NICs 16.

In some cases, the data communication buses 24 connecting the various components may be Peripheral Component Interconnect Express (PCIe) buses or other high-speed communication interfaces. These data communication buses 24 may provide sufficient bandwidth for efficient data transfer and control signaling between the DPU 14, NICs 16, and host device 12.

The daisy chain topology of NICs 16 may offer several advantages. For example, the topology may reduce the number of direct connections between the DPU 14 and the NICs 16, potentially simplifying board layout and reducing system complexity. Additionally, this arrangement may allow for easier scalability, as additional NICs 16 can be added to the chain without having to add direct connections to the DPU 14.

In some embodiments, the DPU 14 may be configured to implement various network management functions across the chain of NICs 16. These functions may include setting encryption parameters, configuring packet encapsulation, managing quality of service settings, and coordinating traffic flow between the NICs 16.

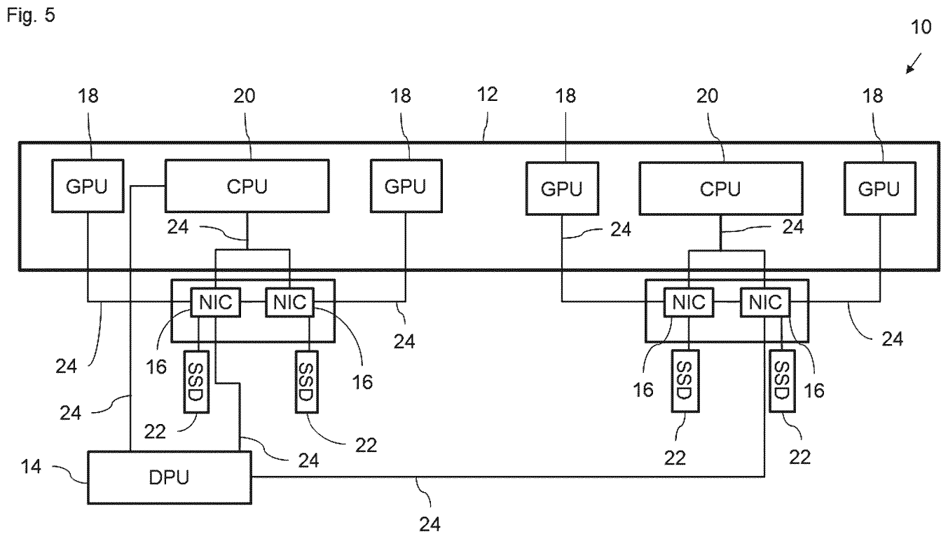

Reference is now made to FIG. 5, which is a detailed block diagram of another configuration of computer node 10. In FIG. 5, the network interface controllers 16 are connected to the host device 12 via data communication buses 24. The data processing unit 14 is connected to some of the network interface controllers 16 via data communication buses 24. These network interface controllers 16 are then connected to other network interface controllers 16 via additional data communication buses 24, forming a daisy chain topology.

A difference in FIG. 5 compared to previous figures is the connection of storage devices 22. In this configuration, the storage devices 22 are connected directly to the network interface controllers 16, rather than to the data processing unit 14. Each network interface controller 16 may have one or more storage devices 22 connected to it via data communication buses 24.

Connecting the storage devices 22 to the network interface controllers 16 may provide several advantages. In some cases, this configuration may allow for more direct and efficient data transfer between the storage devices 22 and the network, potentially reducing latency and improving overall system performance. The network interface controllers 16 may be configured to manage data flow between the storage devices 22 and the network without involving intervention from the data processing unit 14 or the host device 12.

The data processing unit 14 maintains control over the network functionality of the network interface controllers 16, including how they interact with the attached storage devices 22. The data processing unit 14 may send control data through the daisy chain of network interface controllers 16 to configure storage access policies, data routing, or other network-related functions involving the storage devices 22.

This arrangement may provide flexibility in storage allocation and management across the computer node 10. In some cases, different network interface controllers 16 may be associated with different storage devices 22, allowing for customized storage configurations based on the specific requirements of different network interfaces or data flows.

The connection of storage devices 22 to the network interface controllers 16 may also facilitate more efficient data processing in scenarios where data is planned to be quickly transferred between storage and the network. For example, in applications involving high-speed data streaming or large-scale data analytics, this configuration may allow for more direct paths between data storage and network transmission.

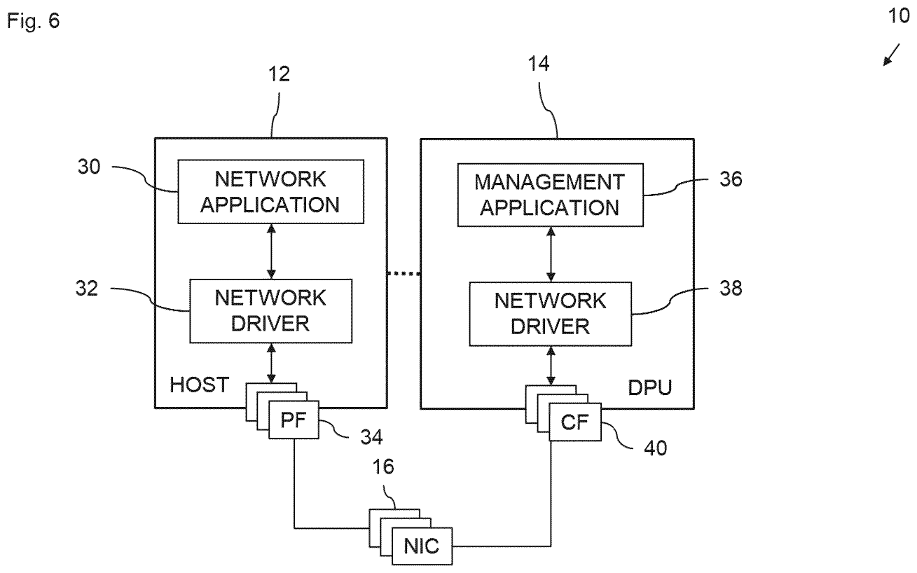

Reference is now made to FIG. 6, which is a block diagram illustrating components of computer node 10 including host device 12 and data processing unit 14. In some cases, the host device 12 may be a bare metal device, meaning it does not utilize a hypervisor or virtualization layer.

The host device 12 includes a network application 30 connected to a network driver 32. The network driver 32 is connected to physical functions 34. The physical functions 34 are connected to network interface controllers 16 for east-west network communication.

The data processing unit 14 includes a management application 36 connected to a network driver 38. The network driver 38 is connected to control functions 40. The control functions 40 is connected to the network interface controllers 16. The data processing unit 14 may be connected to the network interface controllers 16 via at least one data communication bus.

The physical functions 34 enable the host device 12 to communicate through the network interface controllers 16, while the control functions 40 allows the data processing unit 14 to manage and control the network interface controllers 16.

The network application 30 and network driver 32 in the host device 12 handle network communications, while the management application 36 and network driver 38 in the data processing unit 14 manage network control functions.

In some cases, the physical functions 34 may be provided to a tenant in a bare metal configuration, allowing the tenant to believe they have full hardware access. However, certain functionalities related to network interface controller management (e.g., firmware, encryption) may be restricted to prevent overriding configurations programmed by the data processing unit 14 using the control function 40.

The management application 36 may be configured to perform encryption, load balancing, congestion control, quality of service management, and encapsulation. In some cases, a single physical function or virtual function may be used to abstract multiple ports of any network interface controller 16 and expose only one port to the host device 12. The control function 40 on the data processing unit 14 may control how traffic is load-balanced from a physical function to multiple ports of the network interface controller 16.

The architecture illustrated in FIG. 6 allows for flexible and efficient management of network functions. By offloading certain network management tasks to the data processing unit 14, the host device 12 may be freed up to focus on other computational tasks. This separation of network management functions may also enhance security and performance in multi-tenant environments or bare metal configurations.

The software architecture for managing network interface controllers 16 using the data processing unit 14 may be similar to software that would typically run on the host device 12 for managing network functions. However, adaptations may be made to allow this software to run on the data processing unit 14 instead of the host device 12. The network driver 38 on the data processing unit 14 may be modified from a typical host-based network driver 32 to interface with the control function 40 instead of physical functions 34. This modification may allow the network driver 38 to send control data to configure and manage the network interface controllers 16 without directly handling network traffic.

Traffic management may be one function of the data processing unit. The data processing unit may handle routing of both north-south and east-west network traffic, ensuring proper isolation between tenants in multi-tenant environments.

For security policy enforcement, the data processing unit may implement and enforce security policies at the hardware level. This may include managing encryption and decryption of network traffic to prevent unauthorized access or data leakage. In some cases, the control data sent from the data processing unit to a network interface controller may set encryption parameters for network traffic handled by the network interface controller.

Quality of Service (QoS) management may be another function. The data processing unit may prioritize and allocate network resources based on tenant requirements and service level agreements. In some implementations, the control data from the data processing unit may set quality of service parameters for network traffic processed by the network interface controllers.

The data processing unit may also manage virtual network interface controllers (vNICs), providing the illusion of dedicated hardware to each tenant. For example, a network interface controller may have multiple physical ports, but the data processing unit may present a single virtual port to the host system. The data processing unit may then manage how traffic is load-balanced across the different physical ports of the network interface controller.

Packet encapsulation for various network protocols may be controlled by the data processing unit. In some cases, the control data sent to the network interface controllers may set encapsulation parameters for network packets processed by the network interface controllers.

Network virtualization may be implemented by the data processing unit. This may involve implementing network overlay technologies such as Virtual Extensible LAN (VXLAN) or Network Virtualization using Generic Routing Encapsulation (NVGRE) on the DPU 14 and/or NICs 16. The data processing unit 14 may handle the management (and decision making) with respect to encryption, decryption, and encapsulation of network packets for these virtualization technologies on the DPU 14 and/or the NICs 16.

By offloading the above control functions from the host device to the data processing unit, the system may achieve enhanced security, efficient resource allocation, and improved network performance without relying on host-based or hypervisor-based management.

In some cases, the computer node may be utilized for artificial intelligence (AI) data processing in a multi-tenant environment. For example, a cloud service provider may configure multiple computer nodes, each with a host device including at least one processor, to form a distributed AI training cluster. The host devices may include high-performance GPUs for parallel processing of AI workloads.

Multiple network interface controllers may be connected to each host device to enable high-bandwidth east-west network traffic between the host devices within the AI cluster. This east-west traffic may comprise large datasets and model parameters being exchanged between nodes during distributed training. The NICs may process this east-west traffic, allowing direct communication between devices in the same data center network.

A data processing unit may be connected to the NICs in each node via high-speed data communication buses such as PCIe. The DPU may control network functionality of the NICs by sending control data over these buses. For example, the DPU may configure Quality of Service parameters on the NICs to prioritize time-sensitive AI training traffic.

The DPU may also handle north-south network traffic between the host devices and external networks. This may include processing API calls from clients submitting jobs to the AI cluster or retrieving results. By offloading this network processing to the DPU, more host resources can be dedicated to AI computations.

In some cases, the computer nodes may be configured as bare metal instances for customers requesting direct hardware access. The DPU may enable the cloud provider to maintain control over network functionality even in a bare metal environment where hypervisors are not used. For example, the DPU may enforce network isolation between different bare metal tenants sharing the same physical network infrastructure.

The DPU may coordinate with DPUs on other nodes to manage network traffic across the entire AI cluster. This may involve configuring consistent routing policies, encryption standards, and access controls across nodes. By centralizing this network management in the DPUs, consistent policies can be applied without involving software agents on the host devices.

In some cases, the computer node may be used in a multi-tenant cloud environment where different customers run isolated workloads on shared infrastructure. The DPU may create virtual network interfaces and manage traffic segmentation to maintain isolation between tenants. For example, the DPU may configure VLANs or overlay networks on the NICs to logically separate traffic from different tenants.

In some cases, alternative embodiments of the computer node may be implemented with variations in component connections, different types of data processing units and network interface controllers, and alternative data communication bus configurations.

The data processing unit may be implemented using different types of processors or specialized hardware. For example, the data processing unit may be a field-programmable gate array (FPGA), an application-specific integrated circuit (ASIC), or a system-on-chip (SoC) device.

The network interface controllers may also vary in type and capabilities. In some cases, the network interface controllers may include built-in encryption or compression capabilities.

The data communication bus connecting the data processing unit to the network interface controllers may use different protocols or standards. While Peripheral Component Interconnect Express (PCIe) may be used in some embodiments, alternative bus technologies such as InfiniBand, RapidIO, or proprietary interconnects may be employed in other cases.

Alternative embodiments may include different storage configurations. For example, storage devices may be connected directly to the data processing unit, to the network interface controllers, or to a separate storage controller. In some cases, the data processing unit may manage a distributed storage system across multiple network nodes.

In some embodiments, the computer node may include multiple data processing units working in parallel or in a hierarchical arrangement to manage different aspects of network functionality. This may allow for increased scalability and redundancy in network management.

The host device may vary in configuration, potentially including different combinations of central processing units and graphics processing units. In some cases, the host device may be a specialized compute node optimized for specific workloads, such as machine learning or high-performance computing.

Alternative embodiments may implement different virtualization strategies. For example, the data processing unit may create and manage virtual network interface controllers, presenting them to the host device as if they were physical devices. This may allow for more flexible network resource allocation and improved isolation between different workloads or tenants.

The NIC may include any of the following: an Ethernet Port (RJ45 Connector), which is the physical interface where the network cable (usually an Ethernet cable) connects to the NIC and is used for wired network connections; packet processing hardware or circuitry, which is responsible for handling network communication and processes incoming and outgoing data packets and manages the network interface functions; a memory (such as RAM or ROM) to store temporary data, such as network packet buffers, configuration settings, and firmware, and helps in speeding up data transfer and processing; firmware, which is software programmed into the NIC's memory and controls the hardware operations and may perform firmware updates to improve performance or add new features to the NIC; LED Indicators that provide visual indicators of network status, common indicators including power status, network activity, and link speed; a bus Interface (e.g., PCI or PCIe) to connect the NIC to the host computer's motherboard; a processor to handle network processing tasks as well as other processing tasks to offload work from the main CPU of the host device and improve network performance; a heat sink or cooling mechanism (e.g., for high-performance NICs), especially those used in servers, to prevent overheating; power management circuitry to ensure the NIC receives the correct amount of power and manages power consumption efficiently; and/or connector pins and circuitry including internal connections and pathways that route signals between the NIC's components.

The packet processing hardware or circuitry is the central component of the NIC and handles network communications. It may include several components that work together to manage and process network data, such as any one or more of the following: MAC (Media Access Control) Layer, which is responsible for handling the data link layer of the OSI model and manages how data packets are formatted, addressed, and transmitted over the network; MAC address register, which stores the unique hardware address (MAC address) of the NIC; a frame buffer that temporarily holds data frames as they are being processed; a PHY (Physical Layer) Interface that interfaces with the physical medium (such as Ethernet cables) and is responsible for the actual transmission and reception of data bits over the network; a transceiver that converts data between the digital signals used by the MAC layer and the analog signals used for transmission over the network medium; DMA (Direct Memory Access) Controller that manages data transfers between the NIC and the computer's memory without involving the CPU and helps to offload processing tasks from the CPU and improve data transfer efficiency; a packet Processing Engine that handles the encapsulation and decapsulation of network packets, and processes incoming and outgoing packets, managing tasks like error checking and packet filtering; buffer management, which includes memory areas for storing packets temporarily, such as transmit buffers to store packets that are being sent from the computer to the network, receive buffers to store packets received from the network before they are processed by the system; an interrupt controller that manages and generates interrupts to notify the CPU of events such as packet reception or transmission completion and helps in efficient handling of network events; a clock generator, which provides timing signals for the various components of the NIC to synchronize their operations; a power management unit to regulate power consumption and manages power-saving features of the NIC chip to improve energy efficiency; error handling and correction logic, which detects and corrects errors in data transmission and reception, and may include features for error-checking protocols like CRC (Cyclic Redundancy Check); configuration registers that store configuration settings and parameters that control the NIC's operation, such as speed settings, interrupt configurations, and buffer sizes; firmware/ROM that contains the embedded software that controls the NIC's operations and manages network protocols.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form “a”, “an” and “the” include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A network node, comprising:
a host device including at least one processor;
a plurality of network interface controllers (NICs) connected to the host device; and
a data processing unit (DPU) connected to the NICs via at least one data communication bus, the DPU is to control network functionality of the NICs using control data sent via the at least one data communication bus.

2. The network node according to claim 1, wherein:
the DPU processes north-south network traffic and the NICs process east-west network traffic;
north-south network traffic comprises data communication between the host device and external networks; and
east-west network traffic comprises data communications between devices within a same network or data center as the host device.

3. The network node according to claim 1, wherein the DPU is directly connected to at least some of the NICs via the at least one data communication bus.

4. The network node according to claim 3, wherein the control data is sent from the DPU to the NICs not via the host device.

5. The network node according to claim 1, wherein the DPU and the NICs are directly connected to the host device via the at least one data communication bus.

6. The network node according to claim 1, wherein the DPU is connected to at least some of the NICs via a data communication bus switch.

7. The network node according to claim 1, wherein the DPU is not directly connected to the host device.

8. The network node according to claim 7, wherein the DPU is directly connected to the NICs via the at least one data communication bus.

9. The network node according to claim 1, wherein the at least one data communication bus includes at least one Peripheral Component Interconnect Express (PCIe) data bus.

10. The network node according to claim 1, wherein the DPU is directly connected to a subset of the NICs via the at least one data communication bus, and the subset of NICs are directly connected to others of the NICs via the at least one data communication bus.

11. The network node according to claim 1, wherein the control data sets encapsulation parameters for network packets processed by the NICs.

12. The network node according to claim 1, wherein the control data sets encryption parameters for network traffic handled by the NICs.

13. The network node according to claim 1, wherein the control data sets quality of service parameters for network traffic processed by the NICs.

14. The network node according to claim 1, wherein the host device is a bare metal device.

15. A system, comprising:
a plurality of network nodes, each network node comprising:
a host device including at least one processor;
a plurality of network interface controllers (NICs) connected to the host device; and
a data processing unit (DPU) connected to the NICs via at least one data communication bus, the DPU to control network functionality of the NICs using control data sent via the at least one data communication bus; and
a network interconnecting the plurality of network nodes, wherein the DPUs of the network nodes coordinate to manage network traffic across the system.

16. The system according to claim 15, wherein:
for each network node, the DPU processes north-south network traffic and the NICs process east-west network traffic;
north-south network traffic comprises data communication between the host devices and external networks; and
east-west network traffic comprises data communications between the host devices within a same network or data center.

17. The system according to claim 15, wherein the control data sets encapsulation parameters for network packets processed by the NICs.

18. The system according to claim 15, wherein the control data sets encryption parameters for network traffic handled by the NICs.

19. The system according to claim 15, wherein the control data sets quality of service parameters for network traffic processed by the NICs.

20. A method for managing network traffic in a network node, comprising:
providing a host device including at least one processor;
connecting a plurality of network interface controllers (NICs) to the host device;
connecting a data processing unit (DPU) to the NICs via at least one data communication bus;
controlling network functionality of the NICs using control data sent from the DPU via the at least one data communication bus;
processing north-south network traffic using the DPU, wherein north-south network traffic comprises data communications between the host device and external networks; and
processing east-west network traffic using the NICs, wherein east-west network traffic comprises data communications between devices within a same network or data center as the host device.
